(19) United States
(12) Patent Application Publication
(10) Pub. No.: US 2018/0267617 A1
(43) Pub. Date: Sep. 20, 2018

(54) GESTURE RECOGNITION DEVICES AND GESTURE RECOGNITION METHODS

(71) Applicant: RAZER (ASIA-PACIFIC) PTE. LTD., SINGAPORE (SG)

(72) Inventor: Joseph Mario Giannuzzi, Cedar Park, TX (US)

(21) Appl. No.: 15/542,308

(22) PCT Filed: Jan. 9, 2015
(86) PCT No.: PCT/SG2015/000004

§ 371 Date: Jul. 7, 2017

(51) Int. Cl. G06F 3/01; G06K 9/00; G06T 7/593

(52) U.S. Cl. CPC G06F 3/017; G06K 9/00214; G06K 9/00355; G06T 2200/04; G06F 3/011; G06T 7/593; G06K 9/00389

(57) ABSTRACT

According to various embodiments, a gesture recognition device may be provided. The gesture recognition device may include: a sensor configured to determine information (for example position information, forearm placement information and individual finger placement information) of a user of the gesture recognition device; a progress determination circuit configured to determine whether at least a pre-determined portion of a gesture was performed by the user based on the position information; and a gesture determination circuit configured to determine a gesture based on the at least pre-determined portion of the gesture.

### TECHNICAL FIELD

Various embodiments generally relate to gesture recognition devices and gesture recognition methods.

### BACKGROUND

Gesture recognition systems, in various forms have existed for some time; however their usage was until recently restricted to simple gestures. As such, there may be a need for a more advanced gesture recognition.

### SUMMARY OF THE INVENTION

According to various embodiments, a gesture recognition device may be provided. The gesture recognition device may include: a sensor configured to determine position information of a user of the gesture recognition device; a progress determination circuit configured to determine whether at least a pre-determined portion of a gesture was performed by the user based on the position information; and a gesture determination circuit configured to resolve the gesture and triggering its resulting primary actions and secondary action/s.

According to various embodiments, a gesture recognition method may be provided. The gesture recognition method may include: determining position information of a user of the gesture recognition device; determining whether at least a pre-determined portion of a gesture was performed by the user based on the position information; and determining a gesture based on the at least pre-determined portion of the gesture.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1A and FIG. 1B show gesture recognition devices according to various embodiments;

FIG. 1C shows a flow diagram illustrating a gesture recognition method according to various embodiments; and

FIG. 2 shows a diagram illustrating a keying gestures block diagram and a process flow according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

In this context, the gesture recognition device as described in this description may include a memory which is for example used in the processing carried out in the gesture recognition device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

The reference to any prior art in this specification is not, and should not be taken as an acknowledgement or any form of suggestion that the referenced prior art forms part of the common general knowledge in Australia (or any other country).

In order that the invention may be readily understood and put into practical effect, particular embodiments will now be described by way of examples and not limitations, and with reference to the figures.

Various embodiments are provided for devices, and various embodiments are provided for methods. It will be understood that basic properties of the devices also hold for the methods and vice versa. Therefore, for sake of brevity, duplicate description of such properties may be omitted.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled or as mechanically coupled, for example attached or fixed or attached, or just in contact without any fixation, and it will be understood that both direct coupling or indirect coupling (in other words: coupling without direct contact) may be provided.

According to various embodiments, a keying gestures method may be provided. According to various embodiments, a method for use with HMDs (head mounted display) and other recognition systems may be provided.

Advances in gesture recognition systems have led to a proliferation of HW (hardware)/SW (software) solutions that have been applied to various usage models, for example standalone hand and/or finger gesture recognition systems and integrated recognition systems that either enhance or augment the normal, (keyboard/mouse) HID (human interface device) interfaces used in computers and gaming systems.

According to various embodiments, a method for integrating an overarching approach to a gesture recognition engine/system that is in part driven by “keying gestures” may be provided.

Gesture recognition systems, in various forms have existed for some time; however their usage, was until recently restricted to simple gestures, for example including hands and some number of fingers. These systems were burdened with having to sort through a large library of gestures before a gesture could be identified, resolved and acted upon. Processing of the gesture can take a number of processing cycles (which may for example be defined as “N”). If the gesture list is very large and/or if the gesture recognition engine cannot resolve a poorly formed gesture, the processing time may be high (for example it may take “N×Y” cycles, where “Y” may be a factor larger than 1). When the recognition engine cannot resolve the gesture, it may continue to re-examine the gestures until it is resolved, and this may result in a high screen latency as well as a less than robust and repeatable process.

Even with improvements in processors, the addition of local processing and a large reduction in the size of the gesture libraries the latency involved did not allow for advance applications and/or gaming usage models.

While advances in gesture recognition systems continue to occur, the need for a robust and reliable gesture recognition system with good performance (for example with low latency) may be a key to allow for wider adoption in general and use in various high end applications such as HMDs. Latency must be kept to a minimum especially for desktop, video, console and HMD gaming applications. Currently, the latency of a front of screen based implementations may in many cases be too high which may result in a less than ideal or viable game play experience.

According to various embodiments, devices and methods related to keying gestures (in other words: key gestures), quick gestures, HMD gestures, gestures for HMD, short form gestures, and trigger gestures may be provided.

A keying gestures may be defined as a hand and/or finger pose that is derived from a “natural hand” position like that occurs when a user addresses his or her computer system and keyboard, i.e. the position in which the hands of the user are when resting on the palm rest of a keyboard or desk prior to typing on a keyboard. The user may then form a specific gesture (keying gesture) that is universally recognized by a wide range of people. Two examples may be “thumbs up” and an “index finger point”.

According to various embodiments, a recognition system may be provided which allows faster gesture recognition (and therefore lower latency) because the system may be to resolve a complex gesture (e.g. a thumbs up hand gesture or gestures involving two hands plus fingers) when it is partially formed (>50%). The system may be designed for a downward facing camera on a Head Mounted Display so as to reduce arm fatigue and allowing for more natural gestures and aim position.

According to various embodiments, a gesture recognition device may be provided. The gesture recognition device may include: a sensor configured to determine position information of a user of the gesture recognition device; a progress determination circuit configured to determine whether at least a pre-determined portion of a gesture was performed by the user based on the position information; and a gesture determination circuit configured to resolve the gesture and triggering its resulting primary action/s and secondary action/s.

According to various embodiments, devices and methods may be provided to detect a gesture even before it is entirely posed/formed by a user.

According to various embodiments, a gesture recognition device may be provided. The gesture recognition device may include: a sensor configured to determine information (for example position information, forearm placement information and individual finger placement information) of a user of the gesture recognition device; a progress determination circuit configured to determine whether at least a pre-determined portion of a gesture was performed by the user based on the position information; and a gesture determination circuit configured to determine a gesture based on the at least pre-determined portion of the gesture.

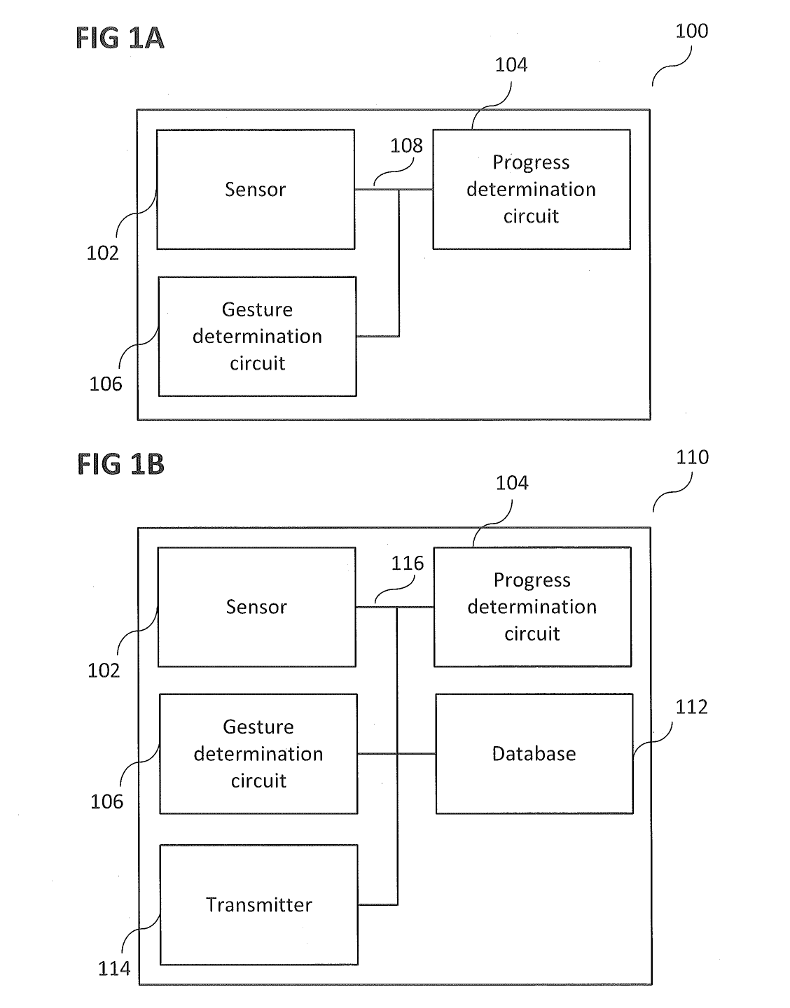

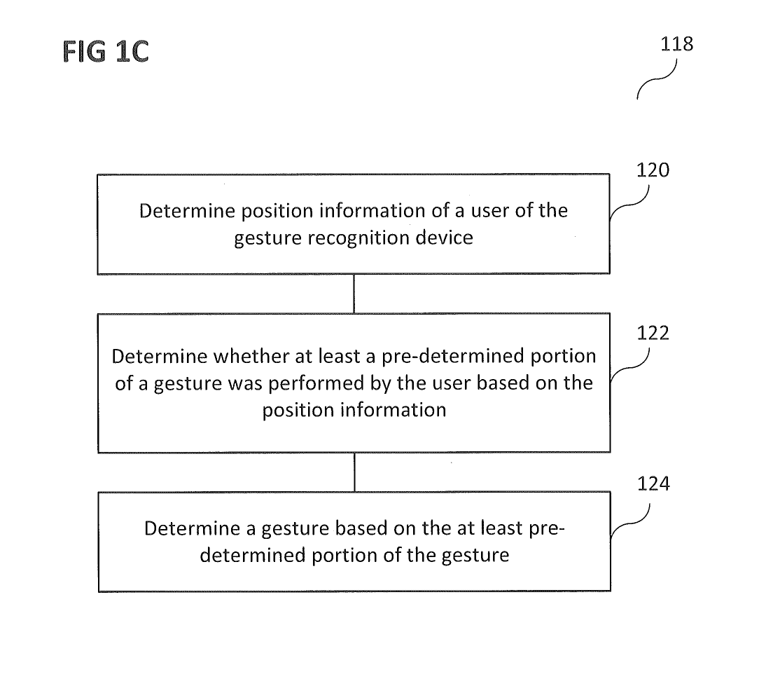

FIG. 1A shows a gesture recognition device 100 according to various embodiments. The gesture recognition device 100 may include a sensor 102 configured to determine position information of a user of the gesture recognition device 100. The gesture recognition device 100 may further include a progress determination circuit 104 configured to determine whether at least a pre-determined portion of a gesture was performed by the user based on the position information. The gesture recognition device 100 may further include a gesture determination circuit 106 configured to determine a gesture based on the at least pre-determined portion of the gesture. The sensor 102, the progress determination circuit 104, and the gesture determination circuit 106 may be coupled with each other, like indicated by lines 108, for example electrically coupled, for example using a line or a cable, and/or mechanically coupled.

In other words, a gesture recognition system according to various embodiments may resolve a keying gesture (in other words: determine a keying gesture) of a user before the user actually finished performing the gesture.

FIG. 1B shows a gesture recognition device 110 according to various embodiments. The gesture recognition device 110 may, similar to the gesture recognition device 100 of FIG. 1A, include a sensor 102 configured to determine position information of a user of the gesture recognition device 110. The gesture recognition device 110 may, similar to the gesture recognition device 100 of FIG. 1A, further include a progress determination circuit 104 configured to determine whether at least a pre-determined portion of a gesture was performed by the user based on the position information. The gesture recognition device 110 may, similar to the gesture recognition device 100 of FIG. 1A, further include a gesture determination circuit 106 configured to determine a gesture based on the at least pre-determined portion of the gesture. The gesture recognition device 110 may further include a database 112, like will be described in more detail below. The gesture recognition device 110 may further include a transmitter 114, like will be described in more detail below. The sensor 102, the progress determination circuit 104, the gesture determination circuit 106, the database 112, and the transmitter 114 may be coupled with each other, like indicated by lines 116, for example electrically coupled, for example using a line or a cable, and/or mechanically coupled.

According to various embodiments, the database 112 may be configured to store information indicating a plurality of pre-determined gestures. According to various embodiments, the gesture determination circuit 106 may further be configured to determine the gesture based on the database 112.

According to various embodiments, the gesture determination circuit 106 may further be configured to determine the gesture based on a probability that the at least pre-determined portion of the gesture and the determined gesture match.

According to various embodiments, that transmitter 114 may be configured to transmit information indicating the gesture determined based on the at least pre-determined portion of the gesture.

According to various embodiments, the progress determination circuit 104 may be further configured to determine whether the user has completed a gesture.

According to various embodiments, the gesture determination circuit 106 may further be configured to determine whether the gesture determined based on the at least pre-determined portion of the gesture and the completed gesture match.

According to various embodiments, the transmitter 114 may further be configured to transmit a revoke indication indicating that the gesture determined based on the at least pre-determined portion of the gesture and the completed gesture do not match if the gesture determination circuit 106 determines that the gesture determined based on the at least pre-determined portion of the gesture and the completed gesture do not match.

According to various embodiments, the transmitter 114 may further be configured to transmit a confirmation indication indicating that the gesture determined based on the at least pre-determined portion of the gesture and the completed gesture match if the gesture determination circuit 106 determines that the gesture determined based on the at least pre-determined portion of the gesture and the completed gesture match.

According to various embodiments, the sensor 102 may include or may be or may be included in at least one of a depth sensor, a camera, a three dimensional scanner, a three dimensional camera, or a distance sensor.

According to various embodiments, the gesture recognition device 110 may be provided on a head mounted display and/or in a head mounted display.

According to various embodiments, the gesture determination circuit 106 may further be configured to determine whether a keying gesture was performed. According to various embodiments, the gesture determination circuit 106 is further configured to determine based on the keying gesture a set of candidate gestures (in other words: a swim lane) for subsequent gesture determination.

According to various embodiments, the keying gesture may include or may be or may be included in a thumbs up gesture, a closed first gesture or a peace sign gesture.

FIG. 1C shows a flow diagram 118 illustrating a gesture recognition method according to various embodiments. In 120, position information of a user of the gesture recognition device may be determined. In 122, it may be determined whether at least a pre-determined portion of a gesture was performed by the user based on the position information. In 124, a gesture may be determined based on the at least pre-determined portion of the gesture.

According to various embodiments, the gesture recognition method may further include storing in a database information indicating a plurality of pre-determined gestures, and determining the gesture based on the database.

According to various embodiments, the gesture recognition method may further include determining the gesture based on a probability that the at least pre-determined portion of the gesture and the determined gesture match.

According to various embodiments, the gesture recognition method may further include transmitting information indicating the gesture determined based on the at least pre-determined portion of the gesture.

According to various embodiments, the gesture recognition method may further include determining whether the user has completed a gesture.

According to various embodiments, the gesture recognition method may further include determining whether the gesture determined based on the at least pre-determined portion of the gesture and the completed gesture match.

According to various embodiments, the gesture recognition method may further include transmitting a revoke indication indicating that the gesture determined based on the at least pre-determined portion of the gesture and the completed gesture do not match if it is determined that the gesture determined based on the at least pre-determined portion of the gesture and the completed gesture do not match.

According to various embodiments, the gesture recognition method may further include transmitting a confirmation indication indicating that the gesture determined based on the at least pre-determined portion of the gesture and the completed gesture match if it is determined that the gesture determined based on the at least pre-determined portion of the gesture and the completed gesture match.

According to various embodiments, determining the position information may include determining the position information based on at least one of a depth sensor, a camera, a three dimensional scanner, a three dimensional camera, or a distance sensor.

According to various embodiments, the gesture recognition method may be performed using at least one of a sensor, for example a set of sensors, (for example a camera) mounted on a head mounted display or in a head mounted display.

According to various embodiments, the gesture recognition method may further include: determining whether a keying gesture was performed; and determining based on the keying gesture a set of candidate gestures for subsequent gesture determination.

According to various embodiments, the keying gesture may include or may be or may be included in a thumbs up gesture, a closed first gesture or a peace sign gesture.

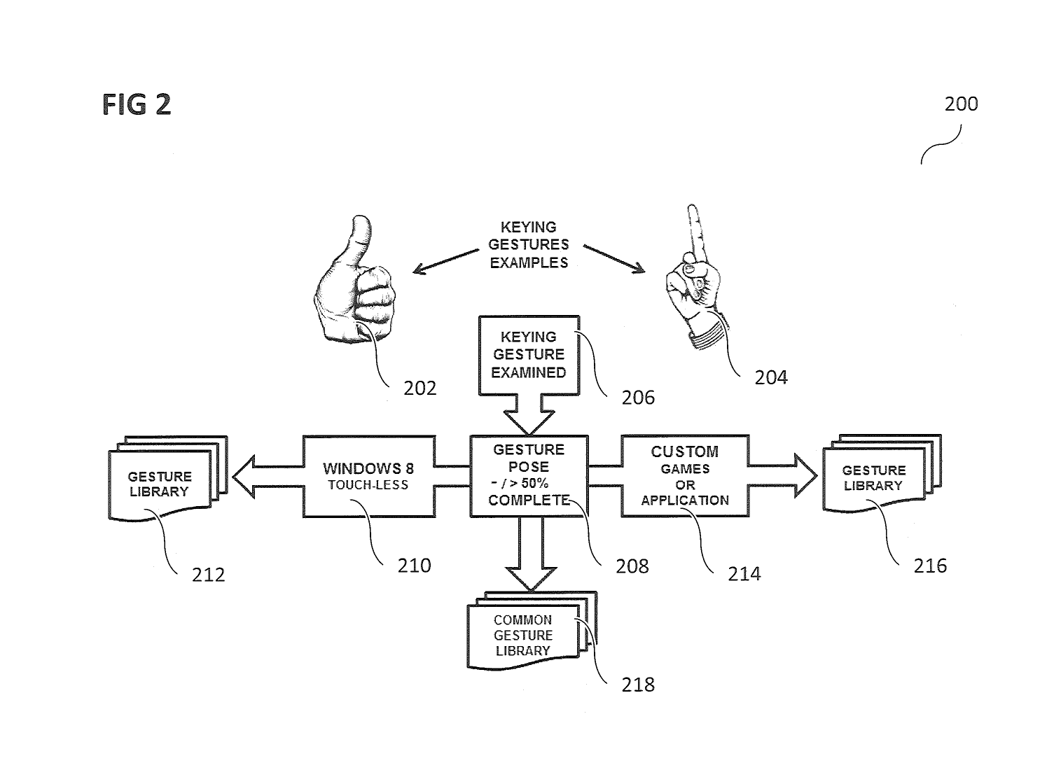

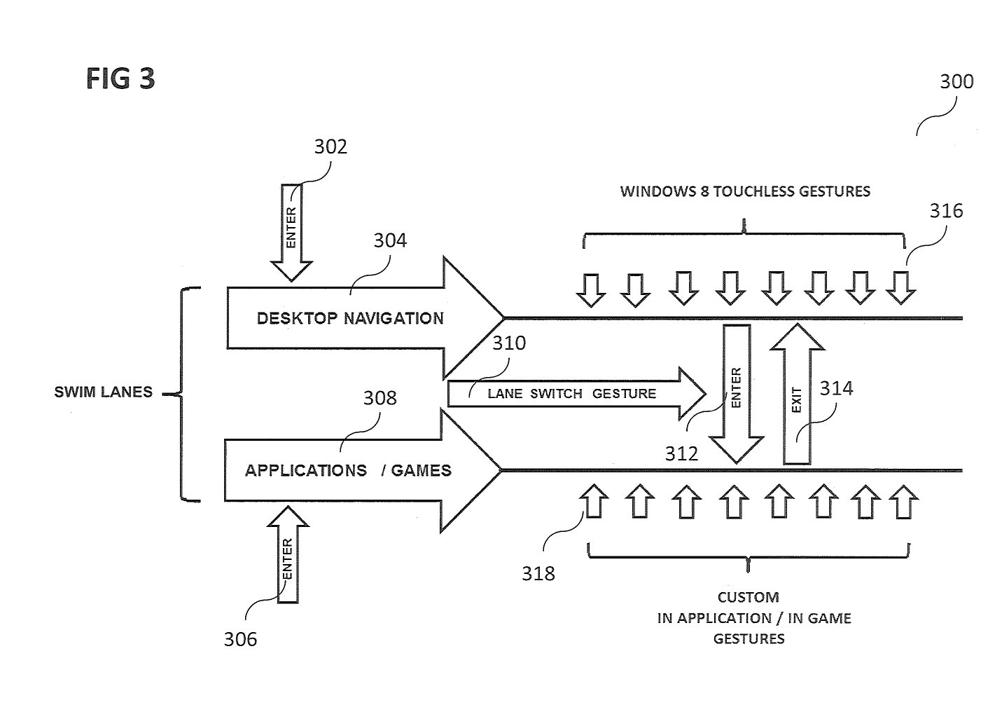

FIG. 2 shows a diagram 200 illustrating a keying gestures block diagram and a process flow according to various embodiments. Examples 202, 204 of keying gestures are shown. In 206, the keying gesture may be examined. In 208, it may be determined whether the gesture pose is more than(in other words “>”, in other words “at least”) 50% complete. In 210, Windows 8 touchless may access a corresponding gesture library 212. In 214, custom games or applications may access a corresponding gesture library 216. In 218, a common gesture library may be accessed. In FIG. 2, 206 refers to the optical acquisition of the posed gestures as perceived by the sensor. 208 refers to how the recognition engine resolved the posed gesture based on >50% of the formed gesture. 210 refers to the predefined Windows 8 touchless gestures poses and/or combination of movements. 210 also refers to one of the “swim Lanes” referenced in various embodiments. 212 refers to the specific library of Windows 8 touchless gestures, specifically what area in memory where the recognition engine would look to find a comparative gesture and or movement. 214 refers to the user defines and store gestures that would be used in an application or game to trigger specific actions or responses to in game events. 214 also refers to one of the two “swim lanes” referenced in various embodiments. 216 refers to the specific library of application or game specific gestures and the specific area in memory where the recognition engine would look to find a comparative gesture and/or combination of movements.

According to various embodiments, a recognition engine may detect and resolve gestures. According to various embodiments, a “keying gesture” may be formed in part based on varying natural hand and finger positions with a camera positioned above and looking down at the user hands as it would be in an HMD application. This approach may also address the “Gorilla Ann Effect” or fatigue factor that exists when the user's arms and hands are in un-natural/elevated positions for too long. According to various embodiments, a refined method may evaluate the gesture being formed/posed, and after that keying gesture is formed to more than (>) 50%, the recognition engine may then resolve that gesture based on the most likely gestures for the set of gestures which are currently likely to be performed (which may also be referred to as a “swim lane” currently being used). For example, all candidate gestures may be classified into two sets (in other words: two classes; which may also be referred to as two “swim lanes”) of gestures. The most likely gestures may be those that are contained within the set of sub-gestures assigned to either one of the two “swim lanes” (for example either Windows 8 touchless gestures/or DT navigation or application/game specific gestures, like will be described with reference to FIG. 3 below). It will be understood that there may be provided a small and focused library of keying gestures for a given application and set of primary and secondary actions. A primary action may be defined as an action which results from a keying gesture that puts the user in a specific swim lane as described in more detail with reference to FIG. 3 below. A secondary action may be defined as an action specific to an application or game or one of the 8 Windows 8 touchless gestures and the sub-action they invoke. The keying gesture may intentionally place the recognition engine into one of several specific paths so that the gesture may be more quickly recognized and resolved, which hence may reduce the latency. Complex gestures such as those that involve two hands plus fingers may greatly benefit from this approach. A primary action may be, assuming the user is in the Windows 8 Touchless gestures “swim lane” any one of the unique gestures defined by Windows to allow for the opening of folder followed by a secondary action which could be the launching of an application with the subject folder. If it is assumed that the user in already in the Application/Game swim lane a primary action could be launching of an application or game. A secondary action may be to select and set application specific setting or within a game performing weapon switch or the casing of spell.

There is no established method or governing standard for the use of gestures outside of the traditional usage models now being used which are based on the front facing approach. A front facing approach may be defined as when the camera/sensor is mounted on a laptop computer facing the user (vs it being mounted on an HMD and facing down focused on the user's forearms and hands). According to various embodiments, methods may provide ease of use in various applications such as when applying a gesture recognition solution to an HMD application. The devices and methods according to various embodiments may be specifically tailored to meet the design goals of a particular product and ensure future expansion and/or the ability of the user or 3rd party solution providers, i.e. game ISVs (independent software vendor) to author custom keying gestures.

FIG. 3 shows a diagram 300 illustrating the gesture determination according to various embodiments. In 302, processing may enter into a desktop navigation route 304. In 306, processing may enter into an applications/games navigation route 308. When the keying gesture is formed to that percent that allows the recognition engine to resolve the gesture, the gesture will be resolved. The recognition engine will put the user in to one of two “swim lanes” (in other words: in a mode in which either set of a plurality of candidate sets is most likely to be performed), and the recognition engine then will know that it will only have to search through a smaller and more specific set of gestures (for example like indicated by 316 and 318) which when detected will trigger primary and then secondary actions The user may remain in the designated swim lane until such time as a lane switch gesture, which may also be referred to as a keying gesture, is formed in 310 (upon which a change of “swim lane” will be carried out in 312 or 314). The process is repeated within the other swim lane and until such time as a “lanes switch” gestures is detected.

According to various embodiments, there may be provided a small set of keying gestures; other gestures may be unique to the swim lane or usage model and may reside within a unique contained library as described with reference to FIG. 2 above. According to various embodiments, within a given swim lane or usage model, non-keying gestures may be repurposed.

According to various embodiments, more than two swim lanes may be provided. Swim lanes may be equated to “usage models” in which a set of pre-determined gestures may be authored to allow for quicker and more predictable interaction within the swim lane or usage model.

According to various embodiments, there may be provided clearly different interaction within a given swim lane/usage model. The advantage may be that once the user is in a swim lane, the recognition engine may only have to search and resolve gesture established for that swim lane/usage model.

According to various embodiments, there may be essentially one pre-determined keying gestures for changing or switching swim lanes, for example a “closed fist” gesture. Reinitiating this gesture may act as a switch and move the user from one swim lane to the other. The gesture may be uniquely authored but may remain in place until and if it was authored, although the re-authoring of the lane changing may be unlikely once established.

According to various embodiments, a swim lane may not initially be entered or exited from unless a keying gesture is posed. For example a thumbs up may be set to allow the user to enter the Windows 8 Touchless Gesture swim lane while initially the Index Finger Point gesture may put the user in the application/games specific swim lane. Exiting a swim lane may, as detailed above, be initiated by a different gesture, and a lane change may be considered.

According to various embodiments, keying gestures may be specific and may be formed/posed by any number of people in the exact same way. There may be no room for interruption by the user. Other keying gestures may be a closed first or a peace sign.

The following examples pertain to further embodiments.

Example 1 is a gesture recognition device comprising: a sensor configured to determine position information of a user of the gesture recognition device; a progress determination circuit configured to determine whether at least a pre-determined portion of a gesture was performed by the user based on the position information; and a gesture determination circuit configured to determine a gesture based on the at least pre-determined portion of the gesture.

In example 2, the subject-matter of example 1 can optionally include a database configured to store information indicating a plurality of pre-determined gestures; wherein the gesture determination circuit is further configured to determine the gesture based on the database.

In example 3, the subject-matter of example 2 can optionally include that the gesture determination circuit is further configured to determine the gesture based on a probability that the at least pre-determined portion of the gesture and the determined gesture match.

In example 4, the subject-matter of any one of examples 1 to 3 can optionally include a transmitter configured to transmit information indicating the gesture determined based on the at least pre-determined portion of the gesture.

In example 5, the subject-matter of any one of examples 1 to 4 can optionally include that the progress determination circuit is further configured to determine whether the user has completed a gesture.

In example 6, the subject-matter of example 5 can optionally include that the gesture determination circuit is configured to determine whether the gesture determined based on the at least pre-determined portion of the gesture and the completed gesture match.

In example 7, the subject-matter of example 6 can optionally include a transmitter configured to transmit information indicating the gesture determined based on the at least pre-determined portion of the gesture; wherein the transmitter is further configured to transmit a revoke indication indicating that the gesture determined based on the at least pre-determined portion of the gesture and the completed gesture do not match if the gesture determination circuit determines that the gesture determined based on the at least pre-determined portion of the gesture and the completed gesture do not match.

In example 8, the subject-matter of any one of examples 6 to 7 can optionally include a transmitter configured to transmit information indicating the gesture determined based on the at least pre-determined portion of the gesture; wherein the transmitter is further configured to transmit a confirmation indication indicating that the gesture determined based on the at least pre-determined portion of the gesture and the completed gesture match if the gesture determination circuit determines that the gesture determined based on the at least pre-determined portion of the gesture and the completed gesture match.

In example 9, the subject-matter of any one of examples 1 to 8 can optionally include that the sensor comprises at least one of a depth sensor, a camera, a three dimensional scanner, a three dimensional camera, or a distance sensor.

In example 10, the subject-matter of any one of examples 1 to 9 can optionally include that the gesture recognition device is provided on a head mounted display or in a head mounted display.

In example 11, the subject-matter of any one of examples 1 to 10 can optionally include that the gesture determination circuit is further configured to determine whether a keying gesture was performed; wherein the gesture determination circuit is further configured to determine based on the keying gesture a set of candidate gestures for subsequent gesture determination.

In example 12, the subject-matter of example 11 can optionally include that the keying gesture comprises at least one gesture selected from a thumbs up gesture, a closed first gesture or a peace sign gesture.

Example 13 is a gesture recognition method comprising: determining position information of a user of the gesture recognition device; determining whether at least a pre-determined portion of a gesture was performed by the user based on the position information; and determining a gesture based on the at least pre-determined portion of the gesture.

In example 14, the subject-matter of example 13 can optionally include: storing in a database information indicating a plurality of pre-determined gestures; and determining the gesture based on the database.

In example 15, the subject-matter of example 14 can optionally include determining the gesture based on a probability that the at least pre-determined portion of the gesture and the determined gesture match.

In example 16, the subject-matter of any one of examples 13 to 15 can optionally include transmitting information indicating the gesture determined based on the at least pre-determined portion of the gesture.

In example 17, the subject-matter of any one of examples 13 to 16 can optionally include determining whether the user has completed a gesture.

In example 18, the subject-matter of example 17 can optionally include determining whether the gesture determined based on the at least pre-determined portion of the gesture and the completed gesture match.

In example 19, the subject-matter of example 18 can optionally include: transmitting information indicating the gesture determined based on the at least pre-determined portion of the gesture; and transmitting a revoke indication indicating that the gesture determined based on the at least pre-determined portion of the gesture and the completed gesture do not match if it is determined that the gesture determined based on the at least pre-determined portion of the gesture and the completed gesture do not match.

In example 20, the subject-matter of any one of examples 18 to 19 can optionally include: transmitting information indicating the gesture determined based on the at least pre-determined portion of the gesture; and transmitting a confirmation indication indicating that the gesture determined based on the at least pre-determined portion of the gesture and the completed gesture match if it is determined that the gesture determined based on the at least pre-determined portion of the gesture and the completed gesture match.

In example 21, the subject-matter of any one of examples 13 to 20 can optionally include that determining the position information comprises determining the position information based on at least one of a depth sensor, a camera, a three dimensional scanner, a three dimensional camera, or a distance sensor.

In example 22, the subject-matter of any one of examples 13 to 21 can optionally include that the gesture recognition method is performed using at least one of a sensor or a camera mounted on a head mounted display or in a head mounted display.

In example 23, the subject-matter of any one of examples 13 to 22 can optionally include: determining whether a keying gesture was performed; and determining based on the keying gesture a set of candidate gestures for subsequent gesture determination.

In example 24, the subject-matter of example 23 can optionally include that the keying gesture comprises at least one gesture selected from a thumbs up gesture, a closed first gesture or a peace sign gesture.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A gesture recognition device comprising:
a sensor configured to determine position information of a user of the gesture recognition device;
a progress determination circuit configured to determine whether at least a pre-determined portion of a gesture was performed by the user based on the position information; and
a gesture determination circuit configured to determine a gesture based on the at least pre-determined portion of the gesture.

2. The gesture recognition device of claim 1, further comprising:
a database configured to store information indicating a plurality of pre-determined gestures;
wherein the gesture determination circuit is further configured to determine the gesture based on the database.

3. (canceled)

4. The gesture recognition device of claim 1, further comprising:
a transmitter configured to transmit information indicating the gesture determined based on the at least pre-determined portion of the gesture.

5. The gesture recognition device of claim 1,
wherein the progress determination circuit is further configured to determine whether the user has completed a gesture.

6. The gesture recognition device of claim 5,
wherein the gesture determination circuit is configured to determine whether the gesture determined based on the at least pre-determined portion of the gesture and the completed gesture match.

7. The gesture recognition device of claim 6, further comprising:
a transmitter configured to transmit information indicating the gesture determined based on the at least pre-determined portion of the gesture;
wherein the transmitter is further configured to transmit a revoke indication indicating that the gesture determined based on the at least pre-determined portion of the gesture and the completed gesture do not match if the gesture determination circuit determines that the gesture determined based on the at least pre-determined portion of the gesture and the completed gesture do not match.

8. The gesture recognition device of claim 6, further comprising:
a transmitter configured to transmit information indicating the gesture determined based on the at least pre-determined portion of the gesture;
wherein the transmitter is further configured to transmit a confirmation indication indicating that the gesture determined based on the at least pre-determined portion of the gesture and the completed gesture match if the gesture determination circuit determines that the gesture determined based on the at least pre-determined portion of the gesture and the completed gesture match.

9. The gesture recognition device of claim 1,
wherein the sensor comprises at least one of a depth sensor, a camera, a three dimensional scanner, a three dimensional camera, or a distance sensor.

10. The gesture recognition device of claim 1,
wherein the gesture recognition device is provided on a head mounted display or in a head mounted display.

11. The gesture recognition device of claim 1,
wherein the gesture determination circuit is further configured to determine whether a keying gesture was performed; and
wherein the gesture determination circuit is further configured to determine based on the keying gesture a set of candidate gestures for subsequent gesture determination.

12. (canceled)

13. A gesture recognition method comprising:
determining position information of a user of the gesture recognition device;
determining whether at least a pre-determined portion of a gesture was performed by the user based on the position information; and
determining a gesture based on the at least pre-determined portion of the gesture.

14. The gesture recognition method of claim 13, further comprising:
storing in a database information indicating a plurality of pre-determined gestures;
determining the gesture based on the database.

15. (canceled)

16. The gesture recognition method of claim 13, further comprising:
transmitting information indicating the gesture determined based on the at least pre-determined portion of the gesture.

17. The gesture recognition method of claim 13, further comprising:
determining whether the user has completed a gesture.

18. The gesture recognition method of claim 17, further comprising:
determining whether the gesture determined based on the at least pre-determined portion of the gesture and the completed gesture match.

19. The gesture recognition method of claim 18, further comprising:
transmitting information indicating the gesture determined based on the at least pre-determined portion of the gesture; and
transmitting a revoke indication indicating that the gesture determined based on the at least pre-determined portion of the gesture and the completed gesture do not match if it is determined that the gesture determined based on the at least pre-determined portion of the gesture and the completed gesture do not match.

20. The gesture recognition method of claim 18, further comprising:
transmitting information indicating the gesture determined based on the at least pre-determined portion of the gesture; and
transmitting a confirmation indication indicating that the gesture determined based on the at least pre-determined portion of the gesture and the completed gesture match if it is determined that the gesture determined based on the at least pre-determined portion of the gesture and the completed gesture match.

21. The gesture recognition method of claim 13,
wherein determining the position information comprises determining the position information based on at least one of a depth sensor, a camera, a three dimensional scanner, a three dimensional camera, or a distance sensor.

22. The gesture recognition method of claim 13,
wherein the gesture recognition method is performed using at least one of a sensor or a camera mounted on a head mounted display or in a head mounted display.

23. The gesture recognition method of claim 13, further comprising:
determining whether a keying gesture was performed; and
determining based on the keying gesture a set of candidate gestures for subsequent gesture determination.

24. (canceled)
